(19) United States
(12) Patent Application Publication
(10) Pub. No.: US 2008/0072938 A1
(43) Pub. Date: Mar. 27, 2008

(54) Lift/immersion bath

(76) Inventor: Robert Sporer, Zaulsdorf (DE)

Correspondence Address: PYLE & PIONTEK LLC, 221 N. LASALLE STREET, SUITE 2036, CHICAGO, IL, 60601, US

(21) Appl. No.: 11/786,363

(22) Filed: Apr. 11, 2007

(30) Foreign Application Priority Data
Apr. 13, 2006 (DE) 10 2006 017 488.7

(51) Int. Cl. B08B 3/00

(52) U.S. Cl. 134/200

(57) ABSTRACT

The lift/immersion system for treating, particularly cleaning, workpieces, comprises at least two chambers into each of which a treatment liquid can be filled which forms an immersion bath, and a lift device as well as a basket connected thereto, into which the workpieces can be put. During the treatment process the basket is moved upwards and downwards through the immersion bath, together with a baffle plate attached thereunder, which displaces treatment liquid during the downward movement and creates turbulences in the immersion bath, whereby the effect of the immersion bath on the articles is strongly enhanced.

The present invention relates to a lift/immersion system for treating, particularly cleaning, workpieces, the system comprising at least two chambers into each of which a treatment liquid, particularly a cleaning liquid, can be filled which forms an immersion bath in the lower portion of the chamber, further comprising a lift device and a lift table connected thereto and provided with passage openings, particularly comprising a basket arranged thereon, into which the workpieces can be placed, and which during the treatment process is movable upwards and downwards in the immersion bath.

With such a system it is not only possible to clean and degrease workpieces, but also for example to de-coat, preserve or phosphate the same, for which purpose the respectively appropriate treatment liquid is used. If, as intended in the present invention, the lift/immersion system comprises at least two chambers, different treatment processes can be carried out in these chambers.

The workpieces to be treated are here first placed on the lift table arranged in the housing or in the basket, respectively, the lift table or basket being lowered during the closing of the lid of the housing, whereupon the treatment process starts. The basket is here moved upwards and downwards in the immersion bath positioned in the chamber, thereby generating a movement of the liquid by which the workpieces are cleaned on all sides.

The systems of that type that have so far been known are of a complicated construction and require a long treatment period to achieve a satisfactory cleaning effect.

It is the object of the present invention to provide a lift/immersion system of the type under consideration which while being of a simple construction achieves a considerably improved treatment effect, and it should be possible-to carry out different treatment processes at the same time.

This object is achieved according to the invention by the features of patent claim 1.

Advantageous developments of the invention are characterized in the subclaims.

According to the invention a baffle plate is attached under each lift table or basket, which plate during the treatment process is moved upwards and downwards in a bottom section of the immersion bath with preferably a small lateral play relative to the walls thereof, so that treatment liquid is displaced during the downward movement and directed at a high pressure through the immersion bath towards the basket and the workpieces arranged thereon. In this process the liquid displaced under the baffle plate generates strong turbulences in the immersion bath, so that the effect of the immersion bath on the articles is considerably intensified. At about 60 lifts/min and a lift path of preferably 50 to 100 mm, the effect created by these turbulences is increased by about 100%.

Furthermore, according to the invention, the lift/immersion system comprises at least two chambers, preferably three or more chambers, in which different treatment processes, preferably with different treatment methods, can be carried out at the same time or one after the other. For instance, the steps pre-cleaning (e.g. with de-coating agents), wash 1 (e.g. with cold cleaner) and wash 2 (with lye-containing water) can take place side by side. A further example is immersion, spraying, splashing, blowing off, drying, and several flushing units may here also be provided.

In further details, it is suggested that the bottom section of the immersion bath is preferably formed by a recess on the bottom of the chamber, a surrounding gap remaining between the walls of said recess and the edge of the baffle plate.

The liquid displaced by the downward movement of the basket and thus of the baffle plate can be directed in different ways and directions onto the workpieces, which may be provided either individually or in combination with one another. According to a first aspect of the invention the baffle plate comprises passage openings for the treatment liquid, which openings may have the shape of small slits and/or holes. When the baffle plate in the trough-like recess is pressed downwards, vigorous liquid jets will pass upwards through the openings of the baffle plate, the jets generating turbulences by reason of the preferably grid-like lift table and impinging with strong currents on the articles, which are thereby efficiently cleaned or otherwise treated by the liquid. In the subsequent upward movement of the lift table and the baffle plate, treatment liquid will again flow back under the baffle plate. To this end valve flaps are preferably provided on the baffle plate, the valve flaps being closed during the downward movement and opened during the upward movement.

It goes without saying that the baffle plate must show enough stiffness to be able to displace the treatment liquid in an efficient manner. In this instance the baffle plate may here be bent on the edges at a flat angle to withstand the pressure of the liquid in a better way.

According to a further aspect of the invention it is suggested that an upright, preferably vertical, flow channel may communicate with the immersion bath, the flow channel extending up to and beyond the upper position of the basket (during the treatment process) and having lateral exit openings from which liquid that has been displaced into the flow channel is directed through the immersion bath towards the workpieces. Hence, these water jets generate flows and turbulences which act from the side and from above on the workpieces and also contribute to an intense cleaning action.

In this development of the invention, the baffle plate may have the above-mentioned passage openings which on the whole must be given smaller dimensions, so that an adequate amount of treatment liquid is additionally displaced into the flow channel, so that vigorous water jets are directed onto the basket from both the bottom and the side and/or top. However, it may also be provided that the baffle plate has a closed surface, so that the water jets during the downward movement of the basket will only exit from the lateral flow channel.

In the side wall of the flow channel, passage openings may be provided for the exit of the liquid, and said passage openings may here also have the shape of small slits and/or holes.

It is within the scope of the present invention to provide at least two separate flow channels that, taken together, can extend substantially over the whole width of the housing, so that all articles arranged in the basket can be covered by the turbulences generated by the exiting liquid jets.

According to a further proposal the lift devices of the at least two chambers are formed by a single joint lift cylinder which in a preferred embodiment is a pneumatic cylinder. The lift cylinder is advantageously arranged near the rear wall of the joint housing of the at least two, preferably three or more, chambers in the center of the housing and drivingly connected to a slide guide that has the baskets of the chambers attached to it. The rear wall of the housing has hinged thereto the collapsible lid of the housing which is able to close all chambers at the top.

It is within the scope of the invention that the lift device can be formed by several piston/cylinder assemblies. One or more electric linear and lifting/lowering units are also possible.

With great advantage it is provided that the lid is opened by the lift cylinder when the baskets are moved fully upwards for removing the workpieces treated. In this process the slide guide, which is connected to the lift cylinder, impinges on the lid, thereby pivoting the lid into the open position. As a result, the whole system just needs one single cylinder, whereby it is given a particularly simple construction. The downwardly directed lift movement simultaneously accomplishes the closing of the pivotable lid by gravity.

Since no electrical connection is required in this embodiment, the system is also best suited for the use of combustible and explosion-prone treatment liquids, such as cleaner's solvent.

It is however within the scope of the invention that aqueous lye, for instance, may also be used as treatment liquid which can e.g. be heated via electric cartridge heaters.

Furthermore, it is suggested with great advantage that the lift/immersion system according to the invention comprises a further chamber, preferably a third chamber, which is provided with a stop for a lower end position of the basket, said end position being located above the immersion bath level. This stop should be arranged to be easily removable so that in case of need an immersion bath can also be used in this chamber.

Furthermore, it is suggested that the further chamber has arranged therein nozzle pipes comprising a plurality of nozzles or simple holes from which liquid jets can be directed onto the basket.

In this chamber liquid jets can also be directed onto the articles located in the basket in cases where an immersion bath should be provided in the lower area for a different treatment process, because in this chamber the associated basket is, unlike in the preferably two adjacent chambers, not lowered into the immersion bath, but is held above the immersion bath level. It goes without saying that the basket is loosely supported on its associated lift table or a corresponding mount, the latter together with its baffle plate being adapted to be lowered together with the adjacent lift tables and performing the lift movements caused by the joint drive device while the articles to be cleaned are held above the immersion bath level and are exposed to the liquid jets ejected from the nozzle pipes.

The at least two, preferably three or more, chambers may be accommodated in a joint housing, preferably having an approximately cubic shape, which may be subdivided by inner walls into the various chambers. However, it may also be that the chambers are each positioned in a separate housing of their own, and it may be expedient for some applications that these housings may have a cylindrical shape or the shape of a barrel.

In a particularly preferred development of the invention the chambers are formed by preferably three or five commercial barrels put into the housing of the lift/immersion system that is preferably rectangular in plan view, whereupon, like in the previously described embodiments, the lift tables provided on a joint yoke with associated slide guides are put with the baskets and the baffle plates attached thereunder into the barrels (or chambers). In this embodiment it is preferred that the barrels with the respective immersion baths are delivered by a service company to the lift/immersion system and fetched again after some time, the service company disposing of the immersion bath media used and providing barrels with new unconsumed media. In this embodiment, too, a single pneumatic piston/cylinder assembly is provided for all chambers or barrels, the assembly being preferably mounted in the middle of the rear wall of the housing and comprising a transverse yoke to which the lift tables of the individual barrels are secured for the joint upward and downward movement.

According to a further proposal of the invention the system may also comprise a device in each chamber for discharging oils, greases and dirt particles deposited on the surface of the treatment bath. To this end a nozzle system may be arranged in the chamber for creating a surface movement, whereby the floating oils and greases are discharged into a laterally flange-mounted stilling pool. The oil/water mixture may also be separated by a suitable oil separator.

In this embodiment of the invention the workpieces will remain after the treatment process in the immersion bath on the lift table or the basket arranged thereon for such a long time until the oils, etc. deposited on the liquid surface have been discharged, whereupon the lift table is lifted into the loading and unloading plane.

Further details of the invention become apparent from the following description of a few preferred embodiments and with reference to the drawings, of which:

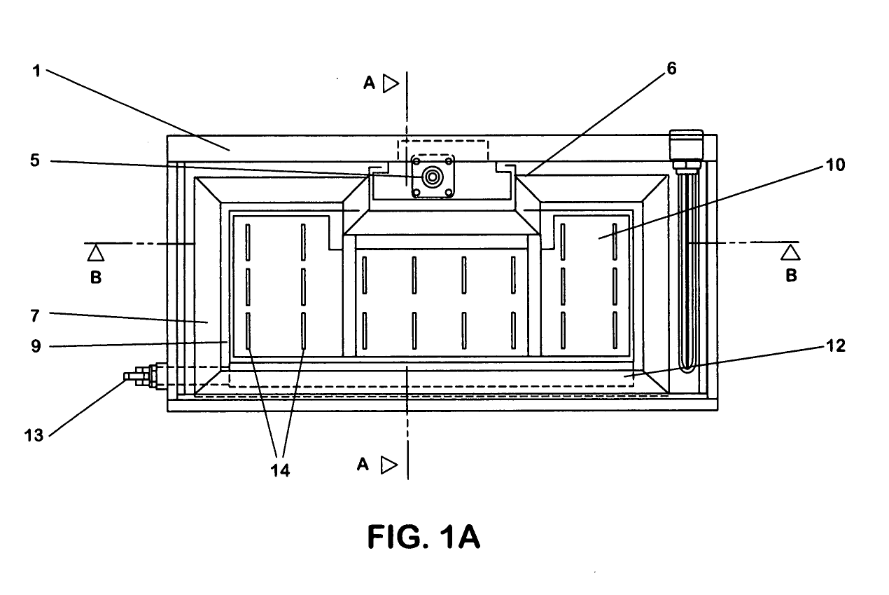

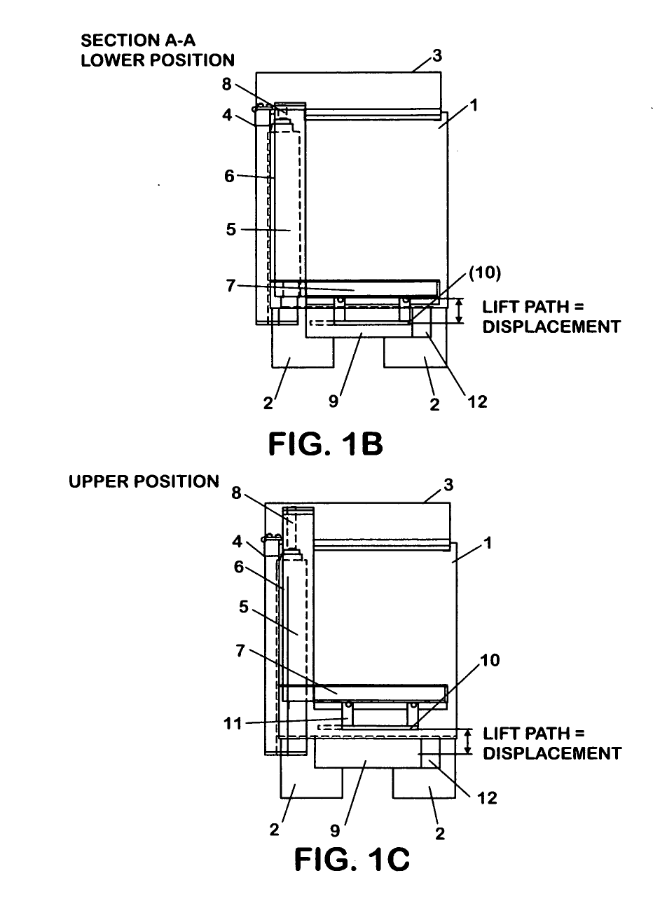

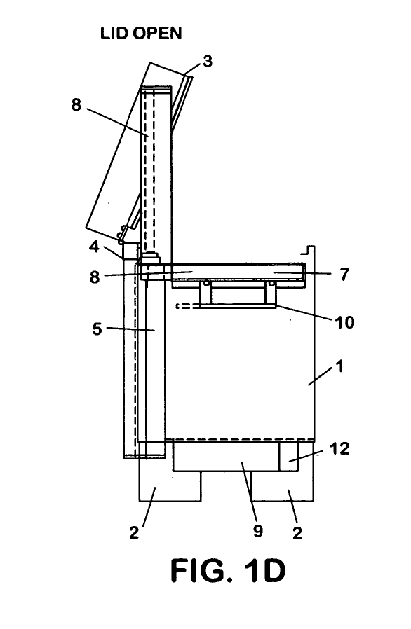

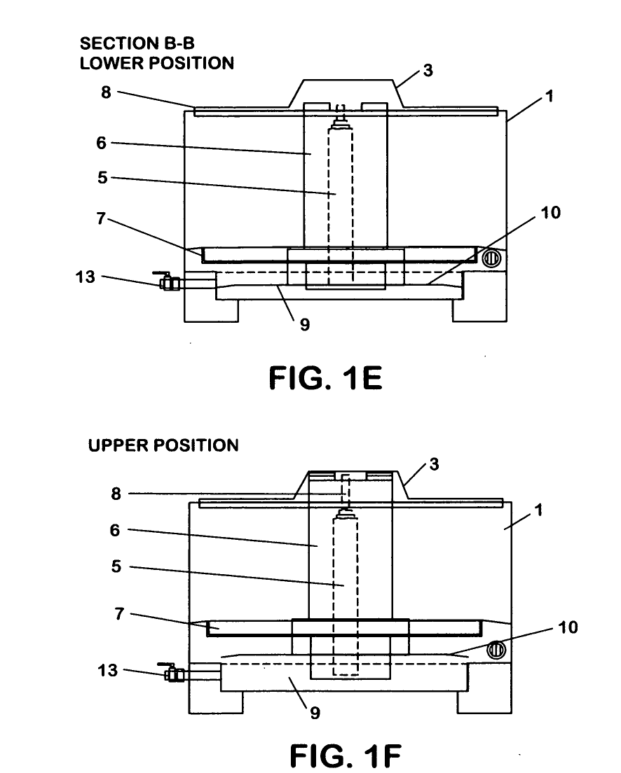

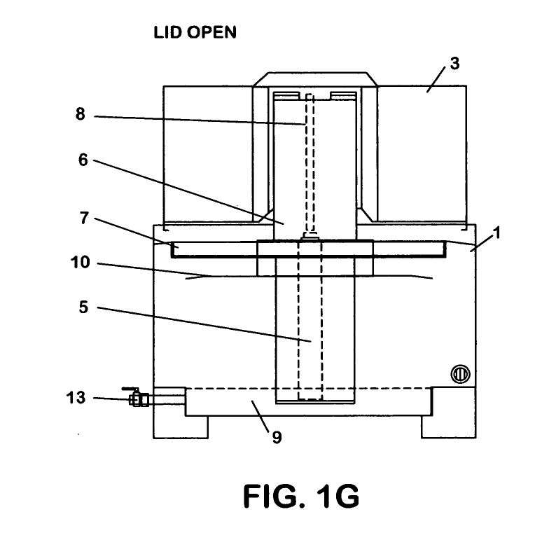

FIG. 1A shows a first embodiment of a chamber of the lift/immersion system in a schematic top view;

FIGS. 1B to 1D show the chamber of the lift/immersion system in schematic side views in the lower position of the lift table, the upper position of the lift table in the treatment process and in the loading and unloading position of the lift table;

FIGS. 1E to 1G show corresponding schematic illustrations of the embodiment from the front;

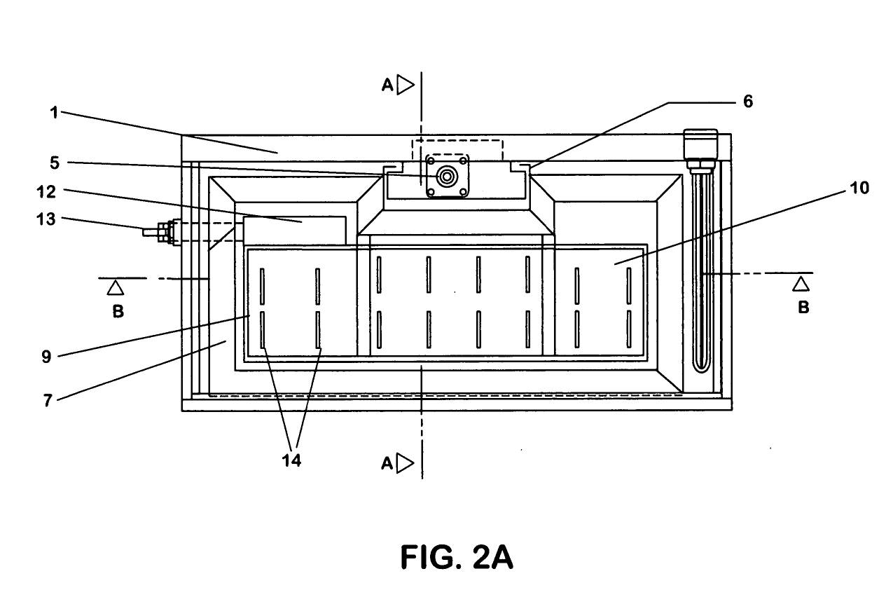

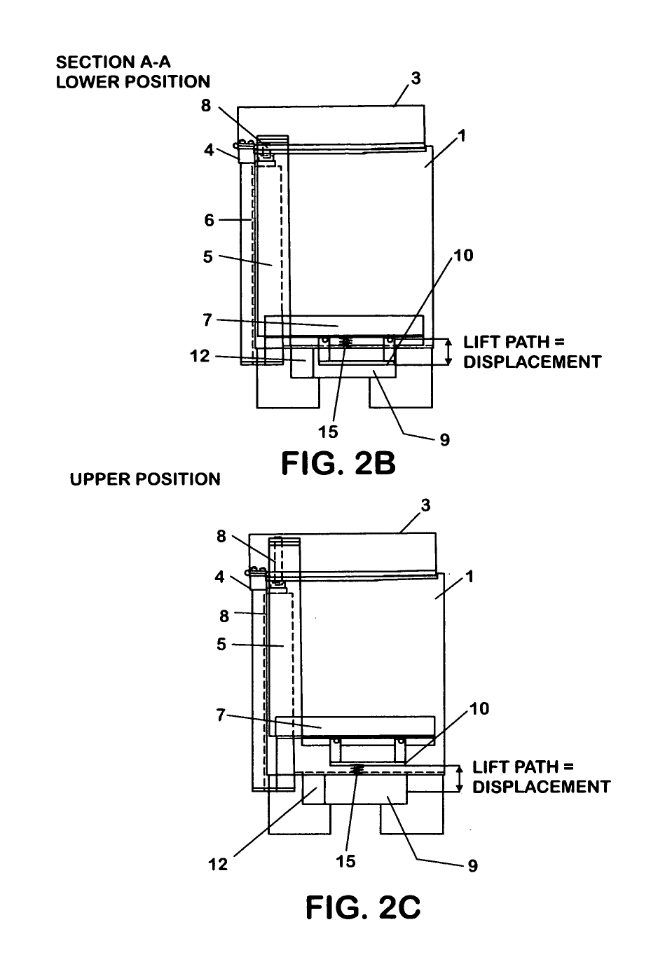

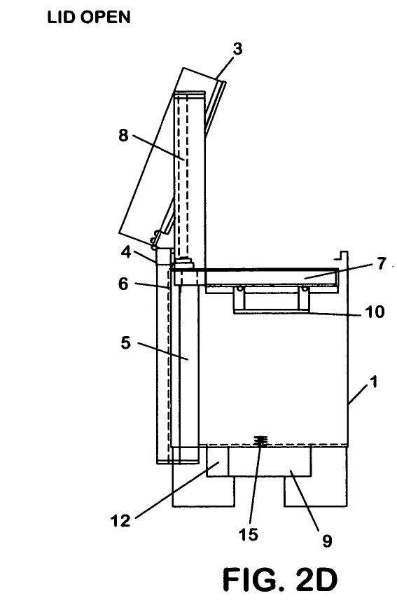

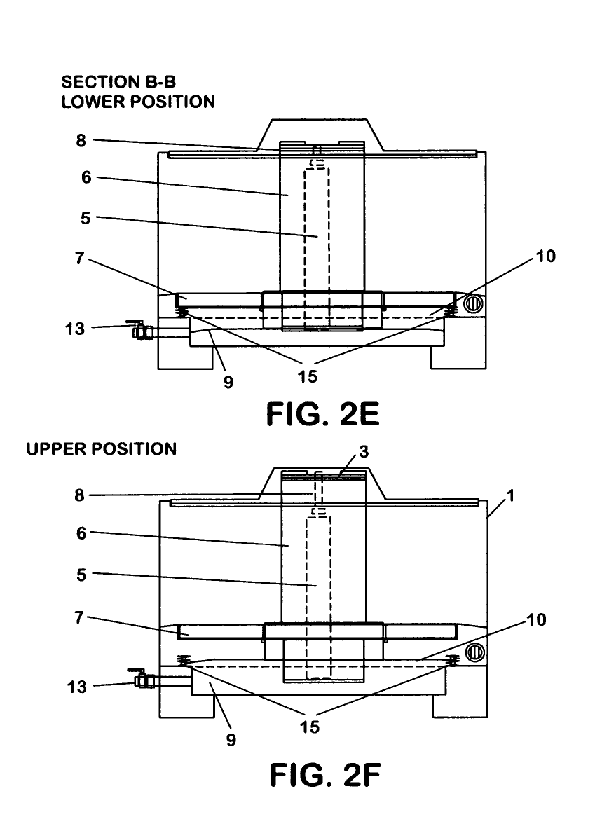

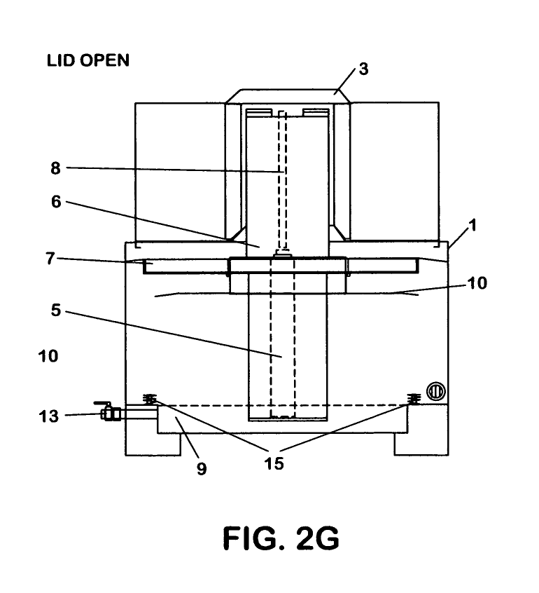

FIG. 2A shows a second embodiment of a chamber of the lift/immersion system in a schematic top view;

FIGS. 2B to 2D show the chamber of the lift immersion system in schematic side views in the lower position of the lift table, the upper position of the lift table during the treatment process and in the loading and unloading position of the lift table;

FIGS. 2E to 2G show corresponding schematic illustrations of the embodiment from the front;

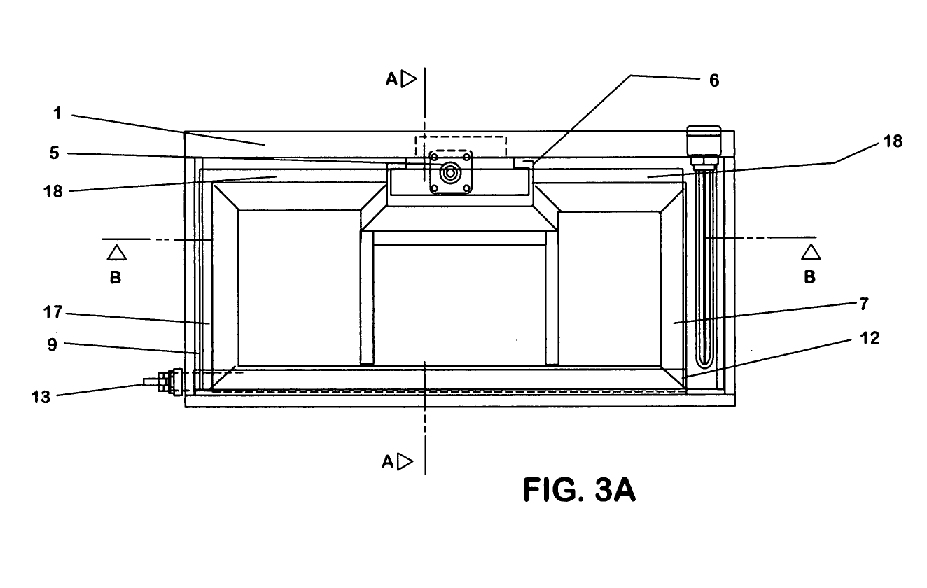

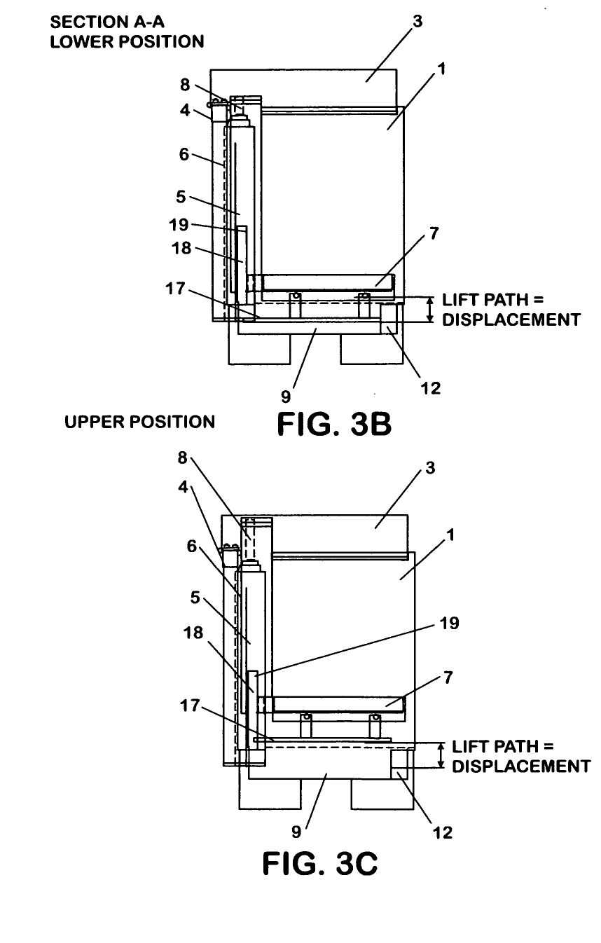

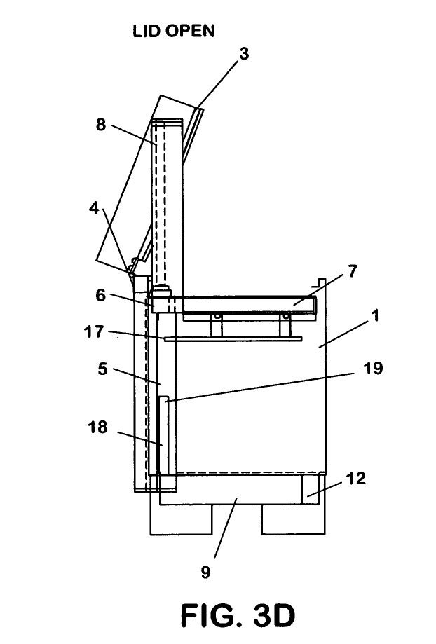

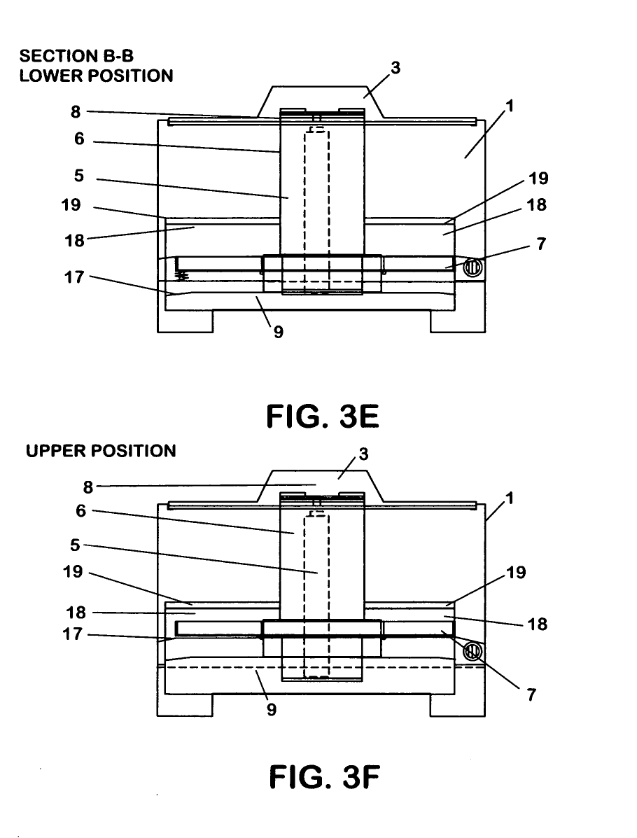

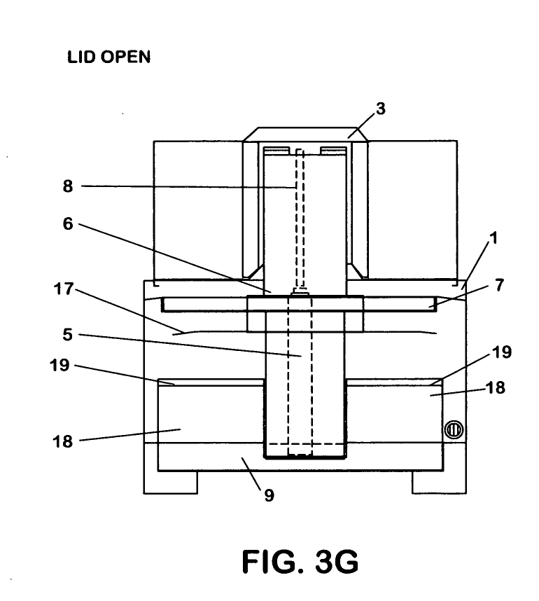

FIG. 3A shows a third embodiment of a chamber of the lift/immersion system in a schematic top view;

FIGS. 3B to 3D show the chamber of lift/immersion system in schematic side views in the lower position of the lift table, the upper position of the lift table during the treatment process and in the loading and unloading position of the lift table;

FIGS. 3E to 3G show corresponding schematic illustrations of the embodiment from the front;

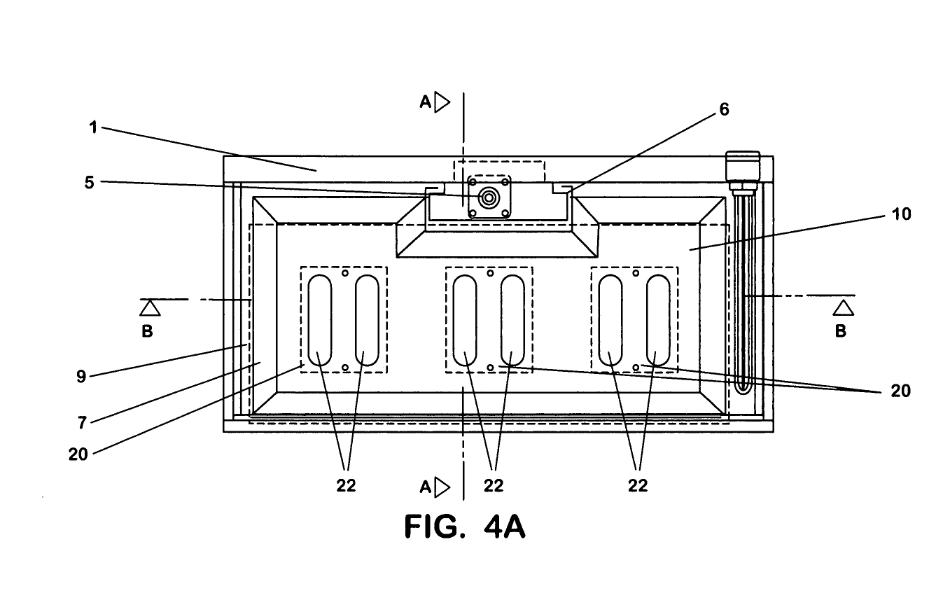

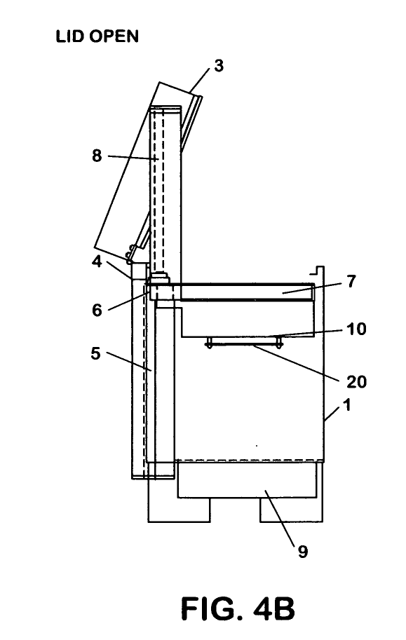

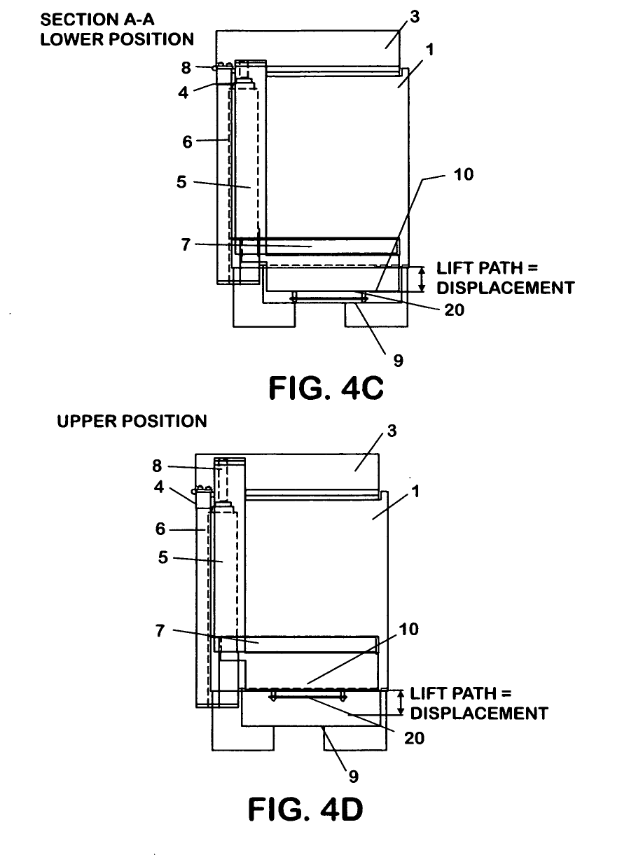

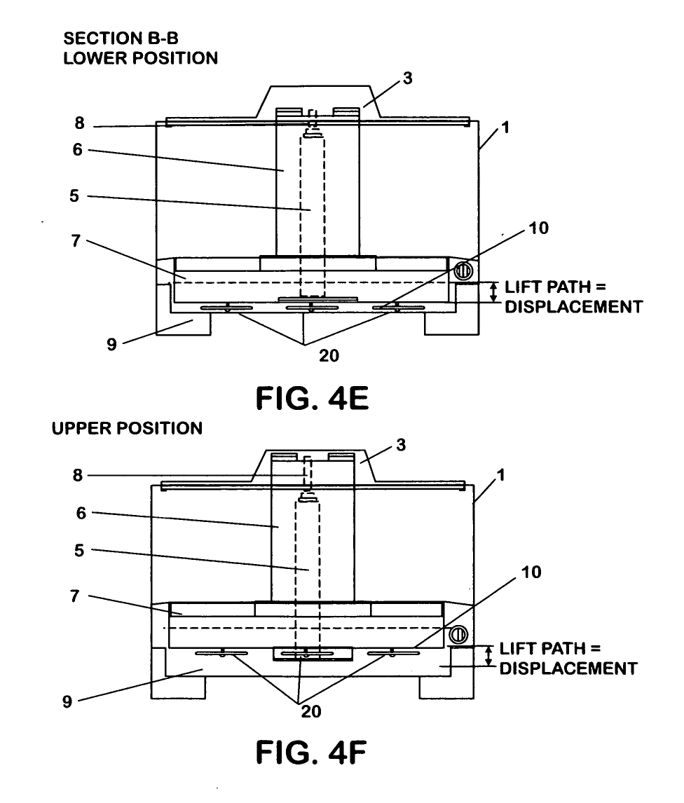

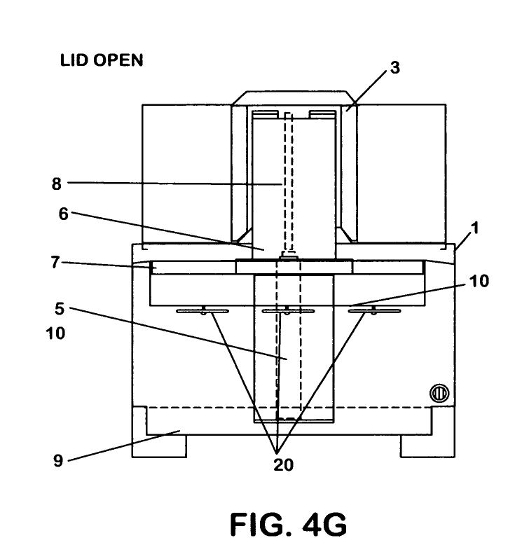

FIG. 4A shows a fourth embodiment of a chamber of the lift/immersion system in a schematic top view;

FIGS. 4B to 4D show the chamber of the lift/immersion system in schematic side views in the lower position of the lift table, the upper position of the lift table during the treatment process and in the loading and unloading position of the lift table;

FIGS. 4E to 4G show corresponding schematic illustrations of the embodiment from the front;

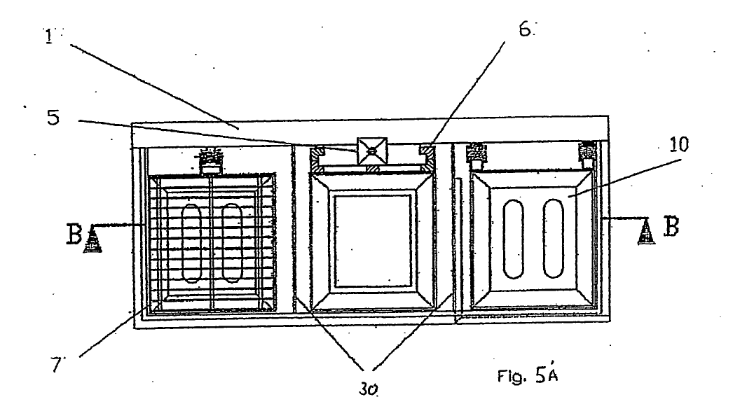

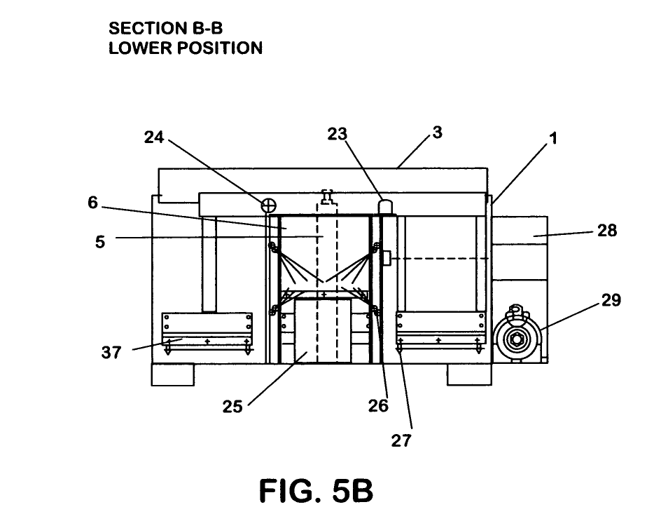

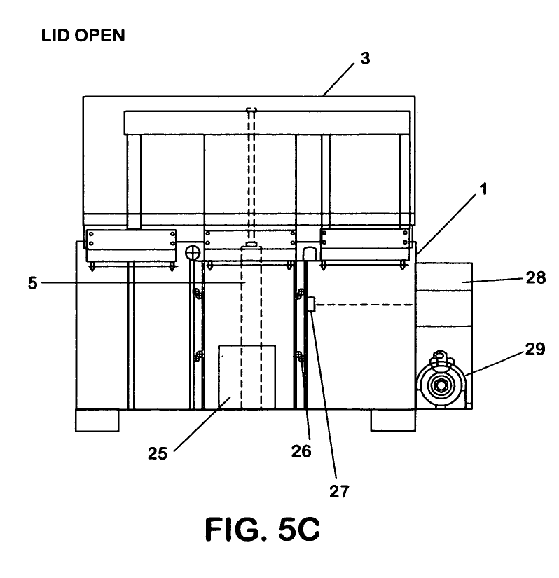

FIG. 5A is a schematic top view on an embodiment of the lift/immersion system with three chambers;

FIGS. 5B and 5C show the lift/immersion system according to FIG. 5A in schematic sectional illustrations from the front in the lower and upper position of the lift tables;

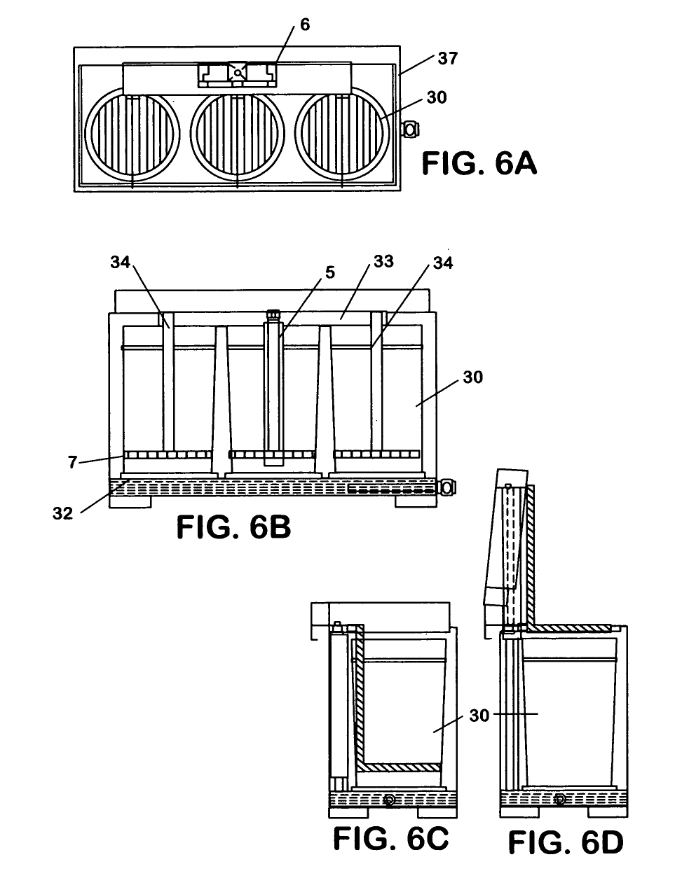

FIG. 6A is a schematic top view on an embodiment of the lift/immersion system with three barrels inserted into the housing;

FIGS. 6B to 6D show the lift/immersion system according to FIG. 6A in schematic sectional illustrations from the front and from the side, the latter in the lower and the upper position of the lift table.

FIGS. 1A to 1G show a first embodiment of a lift/immersion system with a chamber. A tank 1 which is standing on feet 2 is provided with a collapsible lid 3 which is hinged to the rear wall of the tank 1. In the center of the rear wall 4, a vertically oriented pneumatic lift cylinder 4 is mounted in the tank, the cylinder being surrounded by a slide guide 6 for a lift table 7. The piston rod 8 of the lift cylinder 5 is in drive communication with the slide guide 6 element connected to the lift table 7, so that the lift table 7 can be lifted and lowered by the pneumatic piston/cylinder assembly 5.

The lift table 7 includes a grid-like basket for the articles to be treated.

The bottom of tank 1 has formed thereon a trough-like recess 9 into which a baffle plate 10 can enter with a slight lateral play, the baffle plate being attached by webs 11 under the lift table at some distance from said table. Next to the bottom recess 9 a dirt collecting groove 12 is formed which is provided with a drain cock 13 with which collected dirt can be discharged out of the housing 1.

In this embodiment the baffle plate 10 is provided with a multitude of small slits 14 evenly spaced apart in the longitudinal direction of the device. The purpose of said slits shall be described further below.

FIG. 1D shows the loading and unloading position of the lift table 7. In this position, the piston rod 8 of the pneumatic piston/cylinder assembly 5 is completely extended, the slide guide element attached to the lift table 7 lifting the lift table into the uppermost position within housing 1. The slide guide element with the piston rod 8 has here run onto the previously closed lid 3 and has pivoted the lid into the open position shown in FIG. 1D.

After for example articles to be cleaned have been placed on the lift table 7 or put into the grid-like basket thereof, the lift table is moved downwards, the lid moving due to gravity into the closed position. The tank accommodates a treatment bath which in the case of a cleaning process may be lye or, for instance, cleaner's solvent.

After the lid has been closed safely, the lift table 7 is first lowered into the upper position of the treatment process shown in FIGS. 1C and 1F, in which the baffle plate 10 is positioned at a small distance above the edge of the recess 9 on the bottom of the housing. As can be seen from the schematic illustration of FIG. 1F, the baffle plate is bent downwards on two opposite edges at a flat angle.

In the treatment process, e.g. in the cleaning process of the device, the lift table 7 is moved upwards and downwards in the immersion bath at a frequency of preferably 40 to 80 lifts/minute, most preferably 60 lifts/minute between the positions shown in FIGS. 1F/1C and 1B/1E, a lift distance of preferably 50 to 100 mm being covered each time. When the baffle plate in its downward travel dips with a slight lateral play into the recess 9, the treatment liquid is displaced through the slits 14 upwards, the liquid jets causing strong turbulences in the immersion bath that considerably intensify the treatment effect created by the upward and downward movement. The efficiency of the system can easily be doubled by the turbulences generated by the displaced liquid.

In the upper position of the treatment process, the baffle plate 10 is positioned at a distance above the edge of the recess 9, so that previously displaced liquid can again flow back under the baffle plate 10.

The second embodiment shown in FIGS. 2A to 2G differs from the first embodiment in that the dirt collecting groove 12 is arranged at the side of the baffle plate 10 that is oriented towards the lift cylinder 5. In this case, too, the dirt collecting groove is provided with a drain cock 13 leading out of the housing 1. Moreover, buffers 15 are provided outside the movement path of the baffle plate 10 on which the lift table 7 impinges in the lower position. Otherwise, the second embodiment of the invention is identical with the first embodiment.

The third embodiment shown in FIGS. 3A to 3G includes some essential changes. In this embodiment the baffle plate 17 is a closed plate without any passage opening for displaced liquid. The bottom recess 9 into which the baffle plate 17 enters during the treatment process communicates with a vertically upwardly extending flow channel 18 which extends beyond the upper position of the lift table 7 (in the treatment process). In the wall facing the lift table 7 the flow channel 18 has at least one, preferably several, exit slits, of which in the schematic illustrations of FIGS. 3B to 3G only one exit slit 19 arranged on the upper edge is shown. Further slits may be positioned thereunder, but this need not necessarily be the case.

As shown in FIGS. 3E to 3G, the flow channel 19 may also consist of two separate flow channels at both sides of the slide guide 6.

In this embodiment, during the downward movement of the lift table 7 and the baffle plate 17 attached thereto, liquid is displaced out of the recess 9 into the flow channel 18 in which the treatment liquid is pressed upwards and exits out of the slit 19 (and optionally further slits) towards the lift table 7. In this process the ejected water jets create strong turbulences in the immersion bath, the turbulences, in turn, considerably intensifying the treatment effect.

It goes without saying that it is within the scope of the present invention that in the third embodiment slits or holes may also be provided in the baffle plate, so that turbulences, starting from both the baffle plate and the flow channel, are generated in the immersion bath.

FIGS. 4A to 4G show a fourth embodiment similar to the third embodiment. Valve flaps 20 are provided that consist of planar plates displaceably attached to short pins 21 underneath the baffle plate 10. Large passage openings are provided in the baffle plate 10 in the area of the valve flaps 20, the passage openings being covered by the valve flaps 20.

During the downward movement of the baffle plate into recess 9, the counter-pressure of the liquid has the effect that the valve flaps 20 come to rest tightly on the bottom side of the baffle plate 10, whereby the passage openings 22 in the baffle plate are closed. Liquid can thereby be displaced upwards under high pressure out of the recess 9 either through slits of the baffle plate (as in the first two embodiments) and/or between the edges of the baffle plate and the walls of the recess and the housing, thereby forming flow channels.

When the lift table is moved upwards, the valve flaps will slide along the pins a small distance away from the baffle plate until they rest for example on heads of the pins, so that during the upward movement of the baffle plate treatment liquid can pass through the openings 22 under the baffle plate.

As has been stated above, the baffle plate 10 forms flow channels with the walls of the recess and the housing.

The lift/immersion system comprises a device for discharging oils, greases and dirt particles deposited on the surface of the treatment bath. In this discharge device a jet system is provided in the tank 1 for generating a surface movement of the treatment liquid.

FIGS. 5A to 5C show a lift/immersion system in which in a joint housing 1 three adjacently arranged chambers are formed in that the interior of the housing is subdivided by two partitions 30. A joint pneumatic lift cylinder 5 is provided for all of the three lift tables 7 in the chambers, the piston rod 8 of said cylinder being in drive communication with all of the three lift tables through corresponding slide guides. All of the three chambers are closable by a joint lid 3 which is lifted whenever the slide guide elements attached to the lift tables are moved by the piston rod of the lift cylinder into the uppermost position.

While in the two outer chambers the above-described treatment processes are carried out by the lift table being moved upwards and downwards in the immersion bath, the middle chamber comprises a stop 25 for the lower end position of the basket resting on the lift table 7, which is thereby held above the immersion bath level (this chamber may also contain an immersion bath if a different treatment cycle is provided. Otherwise, said chamber is without an immersion bath).

While in the middle chamber the lift table is moved upwards and downwards together with the lift tables in the two other chambers, the articles held in the basket in the lifted position can be treated by liquid jets directed out of nozzle pipes 26 onto the basket.

After the treatment processes have been completed in the three chambers, the lift tables are moved into the upper removal position, the middle lift table carrying the basket along with it.

The end stop 25 for the basket in the middle chamber is arranged in an easily detachable manner, so that after the removal thereof the above-described immersion processes can also be carried out in this chamber.

In the illustration of FIG. 5B, a control box 28 and a pump 29 positioned thereunder are located at the right side next to the joint housing for the three chambers. Reference numerals 23 and 24 designate a slide member and a slide roller while surface nozzles 27 are outlined in the right chamber.

In the embodiment of the invention as shown in FIGS. 6A to 6D, three barrels are placed in a joint housing 31 of the lift/immersion system, namely in ring-shaped mounts 33 provided on the bottom of the housing 31, so that the barrels are stationarily held at the side, but can be removed upwards without any problems. These barrels 30 are preferably supplied to the lift/immersion system with the media respectively forming the immersion bath and are exchanged for barrels with fresh immersion baths after some time.

The pneumatic piston/cylinder assembly 5 is attached to the rear wall of the housing 31 and is again provided with a slide guide 6 on which an upper transverse yoke 33 is mounted, which, in turn, has secured thereto the mounts 34 for the lift tables 7 with the baskets arranged thereon. The pneumatic piston/cylinder assembly 5 can thereby move all of the lift tables rapidly upwards and downwards through the immersion bath at the same time. In this embodiment baffle plates are also secured under each of the lift tables although these are not shown in FIGS. 6A to 6D. The turbulences in the immersion baths can be generated and intensified in many ways by the baffle plates, as has been described further above for the other embodiments of the invention. An embodiment with only one single barrel is also within the scope of the invention. The at least one barrel (or the plurality of barrels) can be heated indirectly.

1. A lift/immersion system for treating, particularly cleaning, workpieces, comprising at least two chambers into each of which a treatment liquid, particularly a cleaning liquid, can be filled which forms an immersion bath in the chamber, further comprising a lift device and a lift table connected thereto and provided with passage openings, particularly comprising a basket into which the workpieces can be placed, and which during the treatment process is movable upwards and downwards through the immersion bath, wherein under the lift tables or baskets of the at least two chambers a baffle plate is respectively attached which during the treatment process can be moved upwards and downwards in a section of the immersion bath, so that treatment liquid is displaced during the downward movement and turbulences are created in the immersion bath.

2. The lift/immersion system according to claim 1,
characterized in
that a gap remains between the walls defining the immersion bath and the edge of the baffle plate.

3. The lift/immersion system according to claim 1,
characterized in
that the baffle plate comprises passage openings for the treatment liquid.

4. The lift/immersion system according to claim 3,
characterized in
that the passage openings are small slits and/or round holes.

5. The lift/immersion system according to claim 1,
characterized in
that the immersion bath has connected thereto at least one upright flow channel which extends up to and beyond the upper position of the basket and has at least one lateral exit opening from which treatment liquid displaced into the at least one flow channel exists and returns into the immersion bath while generating turbulences.

6. The lift/immersion system according to claim 1,
characterized in
that the baffle plate is provided with valve flaps which during the downward movement automatically perform a closing action and automatically perform an opening action during the upward movement of the baffle plate.

7. The lift/immersion system according to claim 1,
characterized in
that the lift devices have a joint piston/cylinder assembly.

8. The lift/immersion system according to claim 7,
characterized in
that a pneumatic piston/cylinder assembly is provided.

9. The lift/immersion system according to claim 1,
characterized by
at least one chamber provided with a stop for a lower end position of the basket which is located above the immersion bath level.

10. The lift/immersion system according to claim 9,
characterized in
that the stop is removable.

11. The lift/immersion system according to claim 1,
characterized in
that the chamber has arranged therein nozzle pipes including a plurality of nozzles, or bores, from which liquid jets can be directed onto the basket.

12. The lift/immersion system according to claim 1,
characterized in
that the at least two, preferably three or more, chambers are accommodated in a joint housing.

13. The lift/immersion system according to claim 1,
characterized in
that the at least two, preferably three, chambers have each a housing of their own.

14. The lift/immersion system according to claim 1,
characterized in
that the chambers are formed by barrels which can be put into the housing of the lift/immersion system and removed again from said housing.
